(19) United States
(12) Patent Application Publication
(10) Pub. No.: US 2021/0261126 A1
(43) Pub. Date: Aug. 26, 2021

(54) SYSTEM AND METHOD FOR VEHICLE LANE ASSIGNMENT

(71) Applicant: Visteon Global Technologies, Inc., Van Buren Township, MI (US)

(72) Inventors: Nikola KARAMANOV, Sofia (BG); Martin PFEIFLE, Seewald (DE); Roumen POPOV, Sofia (BG)

(21) Appl. No.: 16/800,137

(22) Filed: Feb. 25, 2020

(51) Int. Cl. B60W 30/12; G06K 9/00; B60W 60/00; G06K 9/62

(52) U.S. Cl. CPC B60W 30/12; G06K 9/00798; G06K 9/6277; B60W 60/0011; B60W 60/0025

(57) ABSTRACT

A method for vehicle lane assignment includes identifying lane boundaries for one or more lanes of a road being traversed by the vehicle. The method also includes determining a center-line on a per lane basis for the one or more lanes. For a lane, the method uses the respective lane boundaries to determine the respective center-line of the lane. The method also includes determining a lane width on a per lane basis for the one or more lanes. For a lane, the method uses the respective lane boundaries to determine the respective lane width of the lane. The method also includes calculating a first probability that the vehicle is within a first lane of the one or more lanes using the center-line and the lane width corresponding to the first lane. The method also includes determining whether the first probability is greater than a threshold. The method also includes, in response to a determination that the first probability is greater than the threshold, assigning the vehicle to the first lane.

### TECHNICAL FIELD

This disclosure relates to lane detection and in particular to systems and methods or vehicle lane assignment.

### BACKGROUND

Vehicles, such as cars, trucks, sport utility vehicles, crossovers, mini-vans, or other suitable vehicles, are increasingly providing semi-autonomous or autonomous systems to assist operators or passengers of such vehicles in driving and/or in order to provide vehicle control. Semi-autonomous and autonomous systems may include various driver assistance features, such as cruise control, adaptive cruise control, automatic emergency braking, blind spot warning indicators, lane-warning indicators, and/or other suitable driver assistance features or autonomous driving features.

Such features may be configured to automatically control an associated vehicle and/or may provide information to the operator of the vehicle to assist in operating the vehicle. Typically, such systems rely on information, such as vehicle position and/or other information, in order to provide such driver assistance features.

### SUMMARY

This disclosure relates generally to vehicle lane assignment.

An aspect of the disclosed embodiments includes a lane assignment apparatus for vehicle. The apparatus includes a processor and a memory. The memory includes instructions that, when executed by the processor, cause the processor to: identify lane boundaries for one or more lanes of a road being traversed by the vehicle; determine a center-line for a first lane of the one or more lanes using respective lane boundaries of the first lane; determine a lane width for the first lane of the one or more lanes using respective lane boundaries of the first lane; calculate a first probability that the vehicle is within the first lane of the one or more lanes using the center-line and the lane width corresponding to the first lane; determine whether the first probability is greater than a threshold; and in response to a determination that the first probability is greater than the threshold, assign the vehicle to the first lane.

Another aspect of the disclosed embodiments includes a lane assignment method for a vehicle. The method includes identifying lane boundaries for one or more lanes of a road being traversed by the vehicle. The method also includes determining that the lane boundaries form two or more lanes. The method also includes determining center-lines for the two or more lanes using the lane boundaries. The method also includes determining lane widths for the two or more lanes using the lane boundaries. The method also includes calculating a first probability that the vehicle is within a first lane of the two or more lanes using the center-line and the lane width corresponding to the first lane. The method also includes determining whether the first probability is greater than a threshold. The method also includes, in response to a determination that the first probability is greater than the threshold, assigning the vehicle to the first lane.

Another aspect of the disclosed embodiments includes a lane assignment apparatus for vehicle. The apparatus includes a processor and a memory. The memory includes instructions that, when executed by the processor, cause the processor to: identify one or more lanes of a road; determine a center-line per lane of the one or more lanes; determine a lane width per lane of the one or more lanes; calculate a first probability that the vehicle is within a first lane of the one or more lanes using the center-line and the lane width corresponding to the first lane; determine whether the first probability is greater than a hysteresis threshold; in response to a determination that the first probability is greater than the hysteresis threshold, assign the vehicle to the first lane; and selectively adjusting the hysteresis threshold based on a comparison between the first probability, a maximum probability that the vehicle is in the first lane, and a minimum probability that the vehicle is in the first lane.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure.

FIG. 2 generally illustrates a lane assignment system according to the principles of the present disclosure.

FIG. 3 generally illustrates a vehicle traversing a lane according to the principles of the present disclosure.

FIG. 4 is a flow diagram generally illustrating a lane assignment method according to the principles of the present disclosure.

FIG. 5 is a flow diagram generally illustrating an alternative lane assignment method according to the principles of the present disclosure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure. In addition, one skilled in the art will understand that the following description has broad application, and the discussion of any embodiment is meant only to be exemplary of that embodiment, and not intended to intimate that the scope of the disclosure is limited to that embodiment.

Vehicles, such as cars, trucks, sport utility vehicles, crossovers, mini-vans, or other suitable vehicles, are increasingly providing semi-autonomous or autonomous systems to assist operators or passengers of such vehicles in driving and/or in order to provide vehicle control. Semi-autonomous and autonomous systems may include various driver assistance features, such as cruise control, adaptive cruise control, automatic emergency braking, blind spot warning indicators, lane-warning indicators, and/or other suitable driver assistance features or autonomous driving features.

Such features may be configured to automatically control an associated vehicle and/or may provide information to the operator of the vehicle to assist in operating the vehicle. Typically, such systems rely on information, such as vehicle position and/or other information, in order to provide such driver assistance features.

Such information may be obtained, determined, calculated, or received using various techniques, including those described herein. For example, the systems and methods described herein may be configured to use vehicle position and/or other information to assign a vehicle to a lane of travel using uncertainty in determined vehicle positions, uncertainty in lane predictions, vehicle position, and orientation. The systems and methods described herein may be configured to determine current predictions or estimations of vehicle lane assignment using historical vehicle lane assignment predictions or estimations and currently obtained, received, or determined information (e.g., in order to provide smoothing to the probabilities used to determine vehicle lane assignment).

In some embodiments, the systems and methods described herein may be configured to determine a probability of the vehicle being within a lane. The systems and methods described herein may be configured to determine the probability based on a vehicle position relative to identified lane boundaries of a corresponding lane. The systems and methods described herein may be configured to receive the vehicle position and parameters of the identified lane boundaries as given probability distributions to account for noise and uncertainty. The systems and methods described herein may be configured decorrelate parameters of a lane left boundary of a corresponding lane and a lane right boundary of the corresponding lane by determining a lane center-line and lane width. The systems and methods described herein may be configured to use the lane center-line and the lane width to determine a vehicle lane assignment (e.g., instead of the distances from the vehicle to the boundaries).

The systems and methods described herein may be configured to determine a probability distribution for the vehicle lane assignment by conditioning on the centerline and line width. For example, the probability of the vehicle position being within the lane may include the integral of the probability distribution of the vehicle distance from the lane center-line being less than half of the lane width. Which may be defined as:

P left<vehicle<right=(distance from vehicle to centerline<(line width/2))

In some embodiments, the systems and methods described herein may be configured to use hysteresis distributions and/or values to determine the vehicle lane assignment of the vehicle. For example, once the probability of the vehicle position being within each of the road lanes is calculated, the systems and methods described herein may be configured to determine a lane assignment for the vehicle based on the calculated probability and a hysteresis threshold. The systems and methods described herein may be configured to assign the vehicle to the lane if the systems and methods described herein determine that the probability for the vehicle exceeds the hysteresis threshold.

In some embodiments, the systems and methods described herein may be configured to dynamically set and/or adjust the hysteresis threshold. The systems and methods described herein may be configured to determine whether the vehicle probability is a maximum probability for the assigned lane of the vehicle. If the systems and methods described herein determine that the vehicle probability includes the maximum probability, the systems ad methods described herein may be configured to gradually increase the hysteresis threshold up to a maximum value. Conversely, if the systems and methods described herein determine that the vehicle probability indicates a maximum probability for a different lane (e.g., other than the assigned lane of the vehicle), the systems and methods described herein may be configured to gradually decrease the hysteresis threshold down to a minimum value.

In some embodiments, the systems and methods described herein may be configured to reset the hysteresis threshold to an initial value, in response to the systems and methods described herein assigning the vehicle to a new lane. The systems and methods described herein may be configured to adjust the hysteresis threshold based on a vehicle heading relative to the lane. If the systems and methods described herein determine that the vehicle is heading towards the lane, the systems and methods described herein may be configured to decrease the hysteresis threshold. If the systems and methods described herein determine that the vehicle heading indicates that the vehicle is heading away from the lane, the systems and methods described herein may be configured to increase the hysteresis threshold.

In some embodiments, the systems and methods described herein may be configured to identify lane boundaries for one or more lanes of a road being traversed by the vehicle. The systems and methods described herein may be configured to determine a center-line for each of the one or more lanes using respective lane boundaries for each of the one or more lanes. The systems and methods described herein may be configured to determine a lane width for each of the one or more lanes using respective lane boundaries for each of the one or more lanes. The systems and methods described herein may be configured to calculate a first probability that the vehicle is within a first lane of the one or more lanes using the center-line and the lane width corresponding to the first lane. The systems and methods described herein may be configured to calculate the first probability by calculating an integral of a probability distribution of a distance of the vehicle from the center-line corresponding to the first lane being less than half of the lane width corresponding to the first lane.

The systems and methods described herein may be configured to determine whether the first probability is greater than a threshold. In some embodiments, the threshold includes a hysteresis threshold. In some embodiments, the threshold is dynamically adjustable. The systems and methods described herein may be configured to increase the threshold to a maximum value in response to a determination that the first probability includes a maximum probability that the vehicle is in the first lane. The systems and methods described herein may be configured to decrease the threshold to a minimum value in response to a determination that the first probability includes a minimum probability that the vehicle is in the first lane. The systems and methods described herein may be configured to, in response to a determination that the vehicle is heading toward the first lane, decrease the threshold. The systems and methods described herein may be configured to, in response to a determination that the vehicle is heading away from the first lane, increase the threshold. The systems and methods described herein may be configured to, in response to a determination that the first probability is greater than the threshold, assign the vehicle to the first lane.

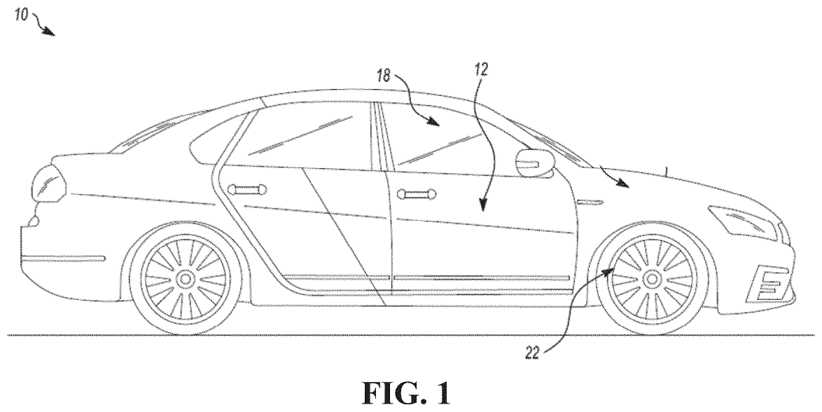

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles. The vehicle 10 includes a vehicle body 12. A portion of the vehicle body 12 defines a passenger compartment 18.

The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In the context of driving automation, the vehicle 10 may be a semi-automated or a fully automated. Under semi-automated driving automation, the vehicle 10 may perform automated driving operations, which may be supervised by an operator or other occupant of the vehicle 10 or may be limited in nature, such as park assist. Under fully automated driving automation, the vehicle 10 may perform automated driving operations, which may be unsupervised by an operator or other occupant of the vehicle 10 and may be independent in nature, such as complete navigation from point A to point B without supervision or control by the operator or other occupant.

The vehicle 10 may include any suitable level of driving automation, such as defined by the society of automotive engineers (e.g., SAE J3016). For example, the vehicle 10 may include features of level 0 automation, level 1 automation, or level 2 automation. For example, the vehicle 10 may include one or more features that assist an operator of the vehicle 10, while requiring the operator of the vehicle 10 to drive the vehicle 10 or at least supervise the operation of the one or more features. Such features may include cruise control, adaptive cruise control, automatic emergency braking, blind spot warning indicators, lane departure warning indicators, lane centering, other suitable features, or a combination thereof.

In some embodiments, the vehicle 10 may include features of level 3 automation, level 4 automation, or level 5 automation. For example, the vehicle 10 may include one or more features that control driving operations of the vehicle 10, without operator or other occupant interaction or supervision of the one or more features by the operator or other occupant. Such features may include a traffic jam chauffeur, limited scenario driverless features (e.g., features that allow the vehicle 10 to operate autonomously, without operator or other occupant interaction or supervision, in specific situations, such as specific route, or other specific situations), fully autonomous driving features (e.g., features that allow the vehicle 10 to drive completely autonomously in every scenario, without operator or other occupant interaction or supervision), or other suitable features. The vehicle 10 may include additional or fewer features than those generally illustrated and/or disclosed herein.

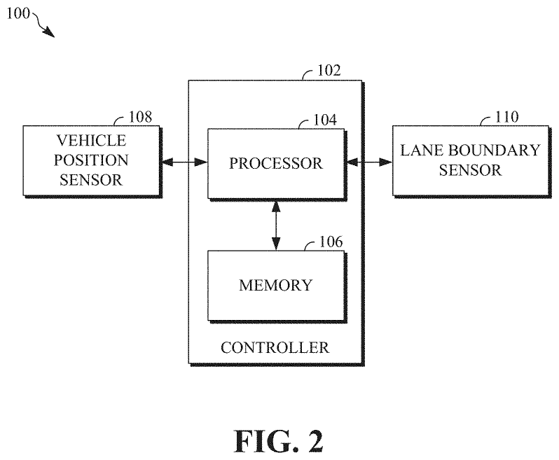

The vehicle 10 may include a lane assignment system 100, as is generally illustrated in FIG. 2. The system 100 may be configured to improve vehicle lane assignment accuracy for the vehicle 10 and/or other vehicles traveling in a same operating environment as the vehicle 10 (e.g., within a range of the vehicle 10). The system 100 may include a controller 102, a vehicle position sensor 108, and a lane boundary sensor 110. The controller 102 may include an electronic control unit or other suitable vehicle controller. The controller 102 may include a processor 104 and memory 106 that includes instructions that, when executed by the processor 104, cause the processor 104 to, at least, determine a lane assignment for the vehicle 10 and/or perform other suitable vehicle operations of the vehicle 10. The processor 104 may include any suitable processor, such as those described herein. The memory 106 may comprise a single disk or a plurality of disks (e.g., hard drives), and includes a storage management module that manages one or more partitions within the memory 106. In some embodiments, memory 106 may include flash memory, semiconductor (solid state) memory or the like. The memory 106 may include Random Access Memory (RAM), a Read-Only Memory (ROM), or a combination thereof.

The vehicle position sensor 108 may be configured to determine a vehicle position within the operating environment of the vehicle. The vehicle position sensor 108 may include any suitable sensor, system, or other mechanism configured to determine the vehicle position of the vehicle 10. For example, the vehicle position sensor 108 may include a global positioning system or sensor, an image capturing device or sensor, a vehicle-to-vehicle communication system, other suitable sensor, system, or mechanism configured to determine the vehicle position of the vehicle 10, or a combination thereof. In some embodiments, the vehicle position sensor 108 is configured to sense the vehicle position of the vehicle 10 relative to various objects in the operating environment, such as lane boundaries, or other suitable objects.

In some embodiments, the vehicle position sensor 108 is configured to receive the vehicle position of the vehicle 10. For example, the vehicle position sensor 108 may receive the vehicle position of the vehicle 10 from a remotely located computing device, such as a cloud-computing device, or other suitable remotely located computing device. Additionally, or alternatively, the vehicle position sensor 108 may be configured to receive a vehicle position of other vehicles operating in the operating environment proximate or within a range of the vehicle 10. It should be understood that the vehicle position sensor 108 may sense, determine, receive, or otherwise obtain the vehicle position of the vehicle 10 and/or other vehicles operating in the operating environment of the vehicle 10 using any suitable technique or mechanism in addition to or other than those described herein. In some embodiments, the vehicle position sensor 108 communicates the vehicle position of the vehicle 10 and/or other vehicles operating in the operating environment of the vehicle 10 to the controller 102 (e.g., and/or the processor 104).

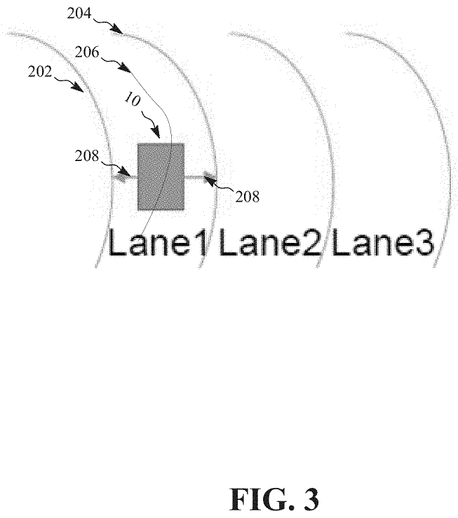

The lane boundary sensor 110 may be configured to identify lane boundaries of lanes of a path being traversed by the vehicle 10. For example, as is generally illustrated in FIG. 3, the vehicle 10 may traverse a path include any suitable number of lanes, including lane 1, lane 2, and lane 3. However, it should be understood the vehicle 10 may traverse any suitable path including any suitable number of lanes. Each of the lanes of the path include a left lane boundary 202 and a right lane boundary 204. The lane boundary sensor 110 may be configured to identify the left lane boundary 202 and the right lane boundary 204 for the lane 1. Similarly, the lane boundary sensor 110 may be configured to identify lane boundaries of the lane 2 and the lane 3.

The lane boundary sensor 110 may include any suitable sensor, system, or other mechanism configured to lane boundaries of the lane. For example, the lane boundary sensor 110 may include an image-capturing device or sensor configured to capture images of operating environment of the vehicle 10. The lane boundary sensor 110 may be configured to identify lane boundary markers that identify the left lane boundary 202 and the right lane boundary 204 and/or other suitable lane boundaries of the lanes using any suitable technique including computing vision techniques configured to identify lane boundaries, other suitable lane boundary identification techniques, or a combination thereof.

In some embodiments, the lane boundary sensor 110 may communicate the images to the controller 102. The controller 102 may be configured to identify the left lane boundary 202, the right lane boundary 204, and other lane boundaries of the lanes using any suitable techniques, including computing vision techniques configured to identify lane boundaries, other suitable lane boundary identification techniques, or a combination thereof. It should be understood that the lane boundary sensor 110 may sense, determine, receive, identify, or otherwise obtain lane boundaries of the lanes in the operating environment of the vehicle 10 using any suitable technique or mechanism in addition to or other than those described herein.

In some embodiments, the controller 102 may be configured to determine a probability of the vehicle 10 being within a lane, such as lane 1, or any other suitable lane. The controller 102 may receive the vehicle position of the vehicle 10 from the vehicle position sensor 108 or any other suitable source. In some embodiments, the controller 102 receives sensor data from the vehicle position sensor 108 and determines the vehicle position of the vehicle 10 using the sensor data. The controller 102 may receive sensor data indicating the lane boundaries for each of the lanes in the operating environment of the vehicle 10. For example, the controller 102 may receive data indicating a location of the left lane boundary 202, the right lane boundary 204, other lane boundaries, or a combination thereof from the lane boundary sensor 110 or any other suitable source.

In some embodiments, the controller 102 may receive the vehicle position and parameters of the left lane boundary 202, the right lane boundary 204, and/or other suitable lane boundaries as given probability distributions from the vehicle position sensor 108 and the lane boundary sensor 110, respective, or any other suitable source. The probability distributions may account for noise and uncertainty in the determined vehicle position and/or the identified lane boundaries. The probability distributions may be defined as:

E[Cᵢ(x)],Var[Cᵢ(x)]∈R

E[σ]∈R²,Var[σ]∈R^{2×2}

Where Cᵢ(x) represents a lane boundary of the lane (e.g., where the lane boundary is represented by Cᵢ(x)˜F_{Ci(x)}_{^{CDF}} and σ is the vehicle position of the vehicle 10 or other suitable vehicle in the operating environment). The probability distributions may be further defined by letting:

$${μ}_{i} ( x ) = E [ {C}_{i} ( x ) ]$$

$${σ}_{i} ( x ) = Var [ {C}_{i} ( x ) ]$$

$$p = ( \begin{matrix}{p}_{x} \\ {p}_{y}\end{matrix} ) = E [ σ ] = E ( \begin{matrix}{σ}_{x} \\ {σ}_{y}\end{matrix} )$$

The controller 102 may be configured to determine the probability that the vehicle 10 is in the lane 1 based on a vehicle position of the vehicle 10 relative to left lane boundary 202 and the right lane boundary 204 of the lane 1. The controller 102 may determine a lane center-line 210 and a lane width 208. The controller 102 may determine the lane width 208 using the left lane boundary 202 and the right lane boundary 204. For example, the controller 102 may determine a distance between the left lane boundary 202 and the right lane boundary 204. The controller 102 may using the probability distributions for the left lane boundary 202 and the right lane boundary 204 to account for noise and uncertainty in the actual location of the left lane boundary 202 and the right lane boundary 204. The controller 102 may determine a probability of the location of the lane width 208 using the probability distributions.

The controller 102 may use the lane center-line 210 and the lane width 208 to determine a vehicle lane assignment. The controller 102 may be configured to determine a probability distribution for the vehicle lane assignment by conditioning on the lane center-line 210 and lane width 208. For example, the probability of the vehicle position being within the lane 1 may include the integral of the probability distribution of the distance of vehicle 10 from the lane center-line 210 being less than half of the lane width 208. Which may be defined as:

P left<vehicle<right=(distance from vehicle to centerline<(line width/2))

The probability that the vehicle 10 is within the left lane boundary 202 and the right lane boundary 204 includes the assignment probability to the lane 1, which may be defined as:

$$P ( {C}_{1} ( {σ}_{x} ) < {σ}_{y} \leq {C}_{2} ( {σ}_{x} ) ) = {\int }_{{R}^{2}} P ( {C}_{1} ( {σ}_{x} ) < {σ}_{y} \leq {C}_{2} ( {σ}_{x} ) \vert σ = μ ) … {f}_{σ} ( μ ) {d}_{μ}$$

Where f_{σ}(μ) is the density of the distribution of a (e.g., or may be referred to as dF_{σ}(μ)), C₁ represents the left lane boundary 202, and C₂ represents the right lane boundary 204. The controller 102 may determine the integral above numerically or by approximation using a sigma points method applied to:

$$N ( P , Var [ σ ] ) \approx {\sum }_{( {s}^{k} , {ω}^{k} )} {ω}^{k} P ( {C}_{1} ( {σ}_{x} ) < {σ}_{y} \leq {C}_{2} ( {σ}_{x} ) \vert σ = {s}^{k} ) = {\sum }_{( {s}^{k} , {ω}^{k} )} {ω}^{k} P ( {C}_{1} ( {s}_{x}^{k} ) < {s}_{y}^{k} \leq {C}_{2} ( {s}_{x}^{k} ) )$$

Where (s^{k}, ω^{k}) represents points and weights of s^{k}ϵR²ω^{k}ξR¹ where the controller 102 determines points via a numerical integration technique (e.g., any suitable integration technique) with the associated weights from an approximation of the density of the distribution, sets all weights from the approximation equal to 1, or determines the points and weights using the sigma points method or technique. Assuming the independence of the left lane boundary 202 and the right lane boundary 204:

$$P ( {C}_{1} ( {s}_{x}^{k} ) < {s}_{y}^{k} \leq {C}_{2} ( {s}_{x}^{k} ) ) = P ( {C}_{1} ( {s}_{x}^{k} ) < {s}_{y}^{k} ) P ( {s}_{y}^{k} \leq {C}_{2} ( {s}_{x}^{k} ) ) = ( 1 - {F}_{{C}_{1 ( {s}_{x}^{k} )}} ( {s}_{y}^{k} ) ) ( {F}_{{C}_{2 ( {s}_{x}^{k} )}} ( {s}_{y}^{k} ) )$$

Where

$${F}_{{c}_{i ( {s}_{x}^{k} )}}$$

may De approximated as:

˜N(μᵢ(sₓ^{k}),σᵢ^{L})sₓ^{k}))

In some embodiments, the controller 102 determines, for each lane (e.g., represented by k):

$${A}_{k} = {ω}^{k} ( 1 - {F}_{{C}_{1 ( {s}_{x}^{k} )}} ( {s}_{y}^{k} ) ) ( {F}_{{c}_{2 ( {s}_{x}^{k} )}} ( {s}_{y}^{k} ) )$$

From

$${F}_{{C}_{i ( {s}_{x}^{k} )}} ∼ N ( {μ}_{i} ( {s}_{x}^{k} ) , {σ}_{i}^{L} ( {s}_{x}^{k} ) )$$

The controller 102 may determine a sum as:

$${\sum }_{k = 1}^{k} {A}_{k}$$

The controller 102 may determine the sum either online or by first storing Aₖ.

In some embodiments, the controller 102 may use hysteresis distributions and/or values to determine the vehicle lane assignment of the vehicle 10. For example, the controller 102 may determine the probability of the vehicle position being within each of the lanes 1, 2, and 3, or any other suitable lanes. The controller 102 may be configured to determine a lane assignment for the vehicle based on the calculated probability and a threshold. The threshold may include a hysteresis threshold or other suitable threshold. The controller 102 compares the probability that the vehicle 10 is in lane 1 with the threshold. If the controller 102 determines that the probability is greater than the threshold, the controller 102 assigns the vehicle 10 to lane 1. Conversely, if the controller 102 determines that the probability is not greater than the threshold, the controller 102 determines whether a probability that the vehicle 10 is in lane 2 is greater than the threshold. The controller 102 may be configured to continue comparing determined probabilities that the vehicle 10 is within lane boundaries corresponding to other lanes with the threshold until the controller 102 identifies a probability that is greater than the threshold. The controller 102 may then assign the vehicle 10 to the lane corresponding to the probability that is greater than the threshold.

In some embodiments, the controller 102 may dynamically set and/or adjust the threshold. For example, the controller 102 may determine whether the probability that the vehicle 10 is in lane 1 includes a maximum probability. If controller 102 determines that the probability includes the maximum probability, the controller 102 may gradually increase the threshold up to a maximum value. Conversely, if controller 102 determines that the probability indicates a maximum probability for a different lane (e.g., indicating that the vehicle 10 is not in lane 1), the controller 102 may gradually decrease the threshold down to a minimum value.

In some embodiments, the controller 102 may reset the threshold to an initial value, in response to the controller 102 assigning the vehicle 10 to a new lane, such as the lane 1. The controller 102 may adjust the threshold based on a vehicle heading relative to the assigned lane. For example, if the controller 102 determines, based on a distance between the vehicle 10 and at least one of the left lane boundary 202 or the right lane boundary 204 (e.g., or any suitable lane boundaries corresponding to the assigned lane), that the vehicle 10 is heading towards another lane, the controller 102 may decrease the threshold. Conversely, if the controller 102 determines, based on a distance between the vehicle 10 and at least one of the left lane boundary 202 or the right lane boundary 204 (e.g., or any suitable lane boundaries corresponding to the assigned lane), that the vehicle 10 is heading away from the another lane, the controller 102 may increase the hysteresis threshold.

While the controller 102 is described as assigning the vehicle 10 to a lane, it should be understood that the controller 102 may identify other vehicle traversing the same path as the vehicle 10 and may determine lane assignments for the other vehicles using the same techniques described herein. This may allow the controller 102 to determine a location of other vehicle relative to the vehicle 10, such that, driver assistance features, such as those described herein, may make operating decisions based on the locations of the vehicle 10 relative to the lane of travel and/or other vehicles traversing the same path in other lanes or the same lane as the vehicle 10.

In some embodiments, the system 100 may perform the methods described herein. However, the methods described herein as performed by system 100 are not meant to be limiting, and any type of software executed on a controller can perform the methods described herein without departing from the scope of this disclosure. For example, a controller, such as a processor executing software within a computing device, can perform the methods described herein.

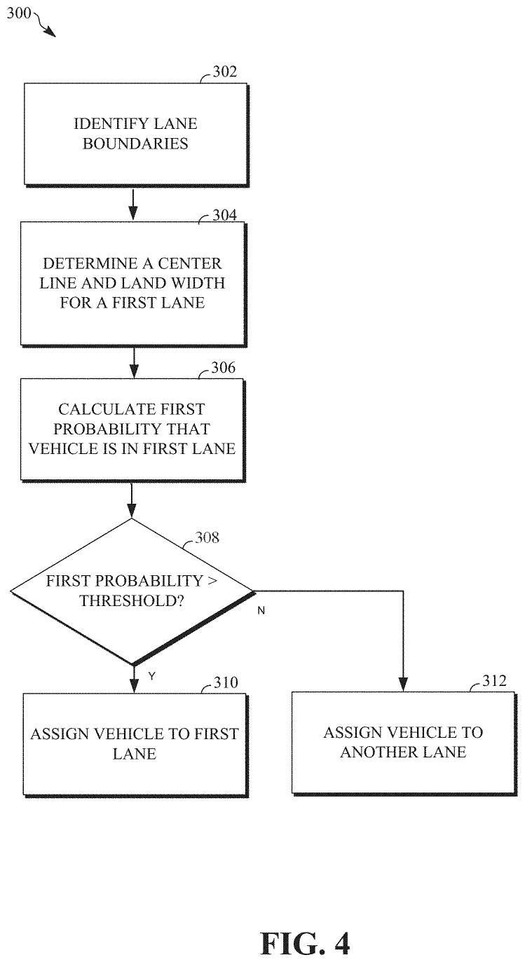

FIG. 4 is a flow diagram generally illustrating a lane assignment method 300 according to the principles of the present disclosure. At 302, the method 300 identifies lane boundaries. For example, the controller 102 identifies the left lane boundary 202, the right lane boundary 204, or other suitable lane boundaries, using any suitable technique.

At 304, the method 300 determines a center-line and a lane width for a first lane. For example, the controller 102 may determine the lane center-line 210 for the lane 1 using the left lane boundary 202 and the right lane boundary 204, as described.

At 306, the method 300 calculates a first probability that the vehicle is in the first lane. For example, the controller 102 calculates or determines the probability (e.g., the first probability) that the vehicle is within the lane 1 using the lane center-line 210 and the lane width 208.

At 308, the method 300 determines whether the first probability is greater than a threshold. For example, the controller 102 determines whether the probability is greater than the threshold. If the controller 102 determines the probability is greater than the threshold, the method 300 continues at 310. If the controller 102 determines that the probability is less than the threshold, the method 300 continues at 312.

At 310, the method 300 assigns the vehicle to the first lane. For example, the controller 102 assigns the vehicle 10 to the lane 1.

At 312, the method 300 assigns the vehicle to another lane. For example, the controller 102 identifies a probability that the vehicle 10 is in one of the other lanes (e.g., lane 2, lane 3, or any suitable lane). The controller 102 determines whether the other probability is greater than the threshold. If the controller 102 determines that the other probability is greater than the threshold, the controller 102 assigns the vehicle 10 to the corresponding lane. The controller 102 continues to determine whether other probabilities of the vehicle 10 being in another lane is greater than the threshold until the controller 102 identifies a probability that is greater than the threshold. The controller 102 then assigns the vehicle 10 to the corresponding lane.

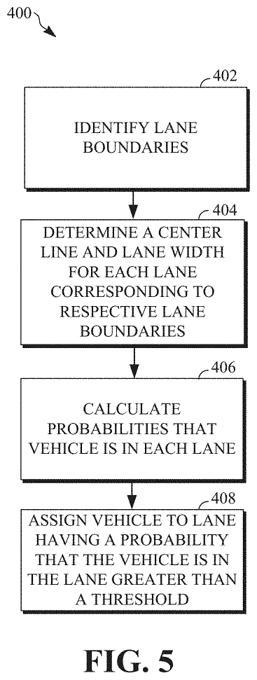

FIG. 5 is a flow diagram generally illustrating an alternative lane assignment method 400 according to the principles of the present disclosure. At 402, the method 400 identifies lane boundaries. For example, the controller 102 identifies the lane boundaries for each of the lanes on the path being traversed by the vehicle 10.

At 404, the method 400 determines a center-line and a lane width for each lane corresponding to respective lane boundaries. For example, the controller 102 may determine the lane center-line 210 for the lane 1 using the left lane boundary 202 and the right lane boundary 204, as described. The controller 102 may determine a center-line for each of the lane 2 and the lane 3 or other suitable lanes, using respective lane boundaries corresponding to each of the lanes. The controller 102 may determine the lane width 208 for the lane 1, as described. The controller 102 may determine lane widths for the lane 2, the lane 3, or any other suitable lanes.

At 406, the method 400 calculates probabilities that the vehicle is in each of the lanes. For example, the controller 102 calculates or determines a probability for each respective lane that the vehicle is within each respective lane.

At 408, the method 400 assigns the vehicle to a lane having a probability that the vehicle is in the lane that is greater than a threshold. For example, the controller 102 compares the determined probabilities that the vehicle 10 is within each of the respective lanes to the threshold. The controller 102 identifies the probability that is greater than the threshold and assigns the vehicle 10 to the corresponding lane.

In some embodiments, a lane assignment apparatus for vehicle includes a processor and a memory. The memory includes instructions that, when executed by the processor, cause the processor to: identify lane boundaries for one or more lanes of a road being traversed by the vehicle; determine a center-line for a first lane of the one or more lanes using respective lane boundaries of the first lane; determine a lane width for the first lane of the one or more lanes using respective lane boundaries for the first lane; calculate a first probability that the vehicle is within the first lane of the one or more lanes using the center-line and the lane width corresponding to the first lane; determine whether the first probability is greater than a threshold; and in response to a determination that the first probability is greater than the threshold, assign the vehicle to the first lane.

In some embodiments, the threshold includes a hysteresis threshold. In some embodiments, the threshold is dynamically adjustable. In some embodiments, the instructions further cause the processor to increase the threshold to a maximum value in response to a determination that the first probability includes a maximum probability that the vehicle is in the first lane. In some embodiments, the instructions further cause the processor to decrease the threshold to a minimum value in response to a determination that the first probability includes a minimum probability that the vehicle is in the first lane. In some embodiments, the instructions further cause the processor to decrease the threshold in response to a determination that the vehicle is heading toward the first lane. In some embodiments, the instructions further cause the processor to increase the threshold in response to a determination that the vehicle is heading away from the first lane. In some embodiments, the instructions further cause the processor to calculate the first probability by calculating an integral of a probability distribution of a distance of the vehicle from the center-line corresponding to the first lane being less than half of the lane width corresponding to the first lane.

In some embodiments, a lane assignment method for a vehicle includes identifying lane boundaries for one or more lanes of a road being traversed by the vehicle. The method also includes determining that the lane boundaries form two or more lanes. The method also includes determining center-lines for the two or more lanes using the lane boundaries. The method also includes determining lane widths for the two or more lanes using the lane boundaries. The method also includes calculating a first probability that the vehicle is within a first lane of the two or more lanes using the center-line and the lane width corresponding to the first lane. The method also includes determining whether the first probability is greater than a threshold. The method also includes, in response to a determination that the first probability is greater than the threshold, assigning the vehicle to the first lane.

In some embodiments, the threshold includes a hysteresis threshold. In some embodiments, the threshold is dynamically adjustable. In some embodiments, the method also includes increasing the threshold to a maximum value in response to a determination that the first probability includes a maximum probability that the vehicle is in the first lane. In some embodiments, the method also includes decreasing the threshold to a minimum value in response to a determination that the first probability includes a minimum probability that the vehicle is in the first lane. In some embodiments, the method also includes, in response to a determination that the vehicle is heading toward the first lane, decreasing the threshold. In some embodiments, the method also includes, in response to a determination that the vehicle is heading away from the first lane, increasing the threshold. In some embodiments, the method also includes calculating the first probability by calculating an integral of a probability distribution of a distance of the vehicle from the center-line corresponding to the first lane being less than half of the lane width corresponding to the first lane.

In some embodiments, a lane assignment apparatus for vehicle a processor and a memory. The memory includes instructions that, when executed by the processor, cause the processor to: determine one or more lanes of a road; determine a center-line per lane of the one or more lanes using respective identified lane boundaries for each of the one or more lanes; determine a lane width per lane of the one or more lanes using respective identified lane boundaries for each of the one or more lanes; calculate a first probability that the vehicle is within a first lane of the one or more lanes using the center-line and the lane width corresponding to the first lane; determine whether the first probability is greater than a hysteresis threshold; in response to a determination that the first probability is greater than the hysteresis threshold, assign the vehicle to the first lane; and selectively adjusting the hysteresis threshold based on a comparison between the first probability, a maximum probability that the vehicle is in the first lane, and a minimum probability that the vehicle is in the first lane.

In some embodiments, the instructions further cause the processor to, in response to a determination that the vehicle is heading toward the first lane, decrease the threshold. In some embodiments, the instructions further cause the processor to, in response to a determination that the vehicle is heading away from the first lane, increase the threshold. In some embodiments, the instructions further cause the processor to calculate the first probability by calculating an integral of a probability distribution of a distance of the vehicle from the center-line corresponding to the first lane being less than half of the lane width corresponding to the first lane.

The above discussion is meant to be illustrative of the principles and various embodiments of the present disclosure. Numerous variations and modifications will become apparent to those skilled in the art once the above disclosure is fully appreciated.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. The term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

What is claimed is:

1. A lane assignment apparatus for a vehicle, the apparatus comprising:
a processor; and
a memory including instructions that, when executed by the processor, cause the processor to:
identify lane boundaries for one or more lanes of a road;
determine a center-line for a first lane of the one or more lanes using respective lane boundaries of the first lane;
determine a lane width for the first lane using respective lane boundaries for each of the first lane;
calculate a first probability that the vehicle is within the first lane of the one or more lanes using the center-line and the lane width corresponding to the first lane;
determine whether the first probability is greater than a threshold; and
in response to a determination that the first probability is greater than the threshold, assign the vehicle to the first lane.

2. The apparatus of claim 1, wherein the threshold includes a hysteresis threshold.

3. The apparatus of claim 1, wherein the threshold is dynamically adjustable.

4. That apparatus of claim 1, wherein the instructions further cause the processor to increase the threshold to a maximum value in response to a determination that the first probability includes a maximum probability that the vehicle is in the first lane.

5. The apparatus of claim 1, wherein the instructions further cause the processor to decrease the threshold to a minimum value in response to a determination that the first probability includes a minimum probability that the vehicle is in the first lane.

6. The apparatus of claim 1, wherein the instructions further cause the processor to, in response to a determination that the vehicle is heading toward the first lane, decrease the threshold.

7. The apparatus of claim 1, wherein the instructions further cause the processor to, in response to a determination that the vehicle is heading away from the first lane, increase the threshold.

8. The apparatus of claim 1, wherein the instructions further cause the processor to calculate, in response to a distance of the vehicle from the center-line of the first lane being less than half of the lane width of the first lane, the first probability by calculating an integral of a probability distribution.

9. A lane assignment method for a vehicle, the method comprising:
identifying lane boundaries of a road being traversed by the vehicle;
determining that the lane boundaries form two or more lanes;
determining center-lines for the two or more lanes using lane boundaries;
determining lane widths the two or more lanes using lane boundaries;
calculating a first probability that the vehicle is within a first lane of the two or more lanes using the center-line and the lane width corresponding to the first lane;
determining whether the first probability is greater than a threshold; and
in response to a determination that the first probability is greater than the threshold, assigning the vehicle to the first lane.

10. The method of claim 9, wherein the threshold includes a hysteresis threshold.

11. The method of claim 9, wherein the threshold is dynamically adjustable.

12. That method of claim 9, further comprising increasing the threshold to a maximum value in response to a determination that the first probability includes a maximum probability that the vehicle is in the first lane.

13. The method of claim 9, further comprising decreasing the threshold to a minimum value in response to a determination that the first probability includes a minimum probability that the vehicle is in the first lane.

14. The method of claim 9, further comprising, in response to a determination that the vehicle is heading toward the first lane, decreasing the threshold.

15. The method of claim 9, further comprising, in response to a determination that the vehicle is heading away from the first lane, increasing the threshold.

16. The method of claim 9, further comprising calculating, in response to a distance of the vehicle from the center-line of the first lane being less than half of the lane width of the first lane, the first probability by calculating an integral of a probability distribution.

17. A lane assignment apparatus for vehicle, the apparatus comprising:
a processor; and
a memory including instructions that, when executed by the processor, cause the processor to:
identify one or more lanes of a road;
determine a center-line per lane of the one or more lanes;
determine a lane width per lane of the one or more lanes;
calculate a first probability that the vehicle is within a first lane of the one or more lanes using the center-line and the lane width corresponding to the first lane;
determine whether the first probability is greater than a hysteresis threshold;
in response to a determination that the first probability is greater than the hysteresis threshold, assign the vehicle to the first lane; and
selectively adjusting the hysteresis threshold based on a comparison between the first probability, a maximum probability that the vehicle is in the first lane, and a minimum probability that the vehicle is in the first lane.

18. The apparatus of claim 17, wherein the instructions further cause the processor to, in response to a determination that the vehicle is heading toward the first lane, decrease the threshold.

19. The apparatus of claim 17, wherein the instructions further cause the processor to, in response to a determination that the vehicle is heading away from the first lane, increase the threshold.

20. The apparatus of claim 17, wherein the instructions further cause the processor to calculate, in response to a distance of the vehicle from the center-line of the first lane being less than half of the lane width of the first lane, the first probability by calculating an integral of a probability distribution.
